(19) United States
(12) Patent Application Publication
(10) Pub. No.: US 2026/0106049 A1
(43) Pub. Date: Apr. 16, 2026

(54) ELECTRODE WIRE FOR ELECTRICAL DISCHARGE MACHINING

(71) Applicant: Proterial, Ltd., Tokyo (JP)

(72) Inventors: Hiroyoshi HIRUTA, Tokyo (JP); Yosuke SHIBA, Tokyo (JP); Hiromitsu KURODA, Tokyo (JP); Shingo AMEMIYA, Tokyo (JP)

(21) Appl. No.: 19/317,519

(22) Filed: Sep. 3, 2025

(30) Foreign Application Priority Data
Oct. 16, 2024 (JP) 2024-180783

(51) Int. Cl. H01B 1/02; H01B 5/06

(52) U.S. Cl. CPC H01B 1/026; H01B 5/06

(57) ABSTRACT

An electrode wire for electrical discharge machining is provided. An electrode wire for electrical discharge machining of the present disclosure has a mass ratio of copper of 55.5 mass % or more and 58.5 mass % or less, a mass ratio of zinc of 41.5 mass % or more and 44.5 mass % or less, a diameter of 0.395 mm or more and 0.45 mm or less, and a tensile strength of 900 MPa or higher.

### CROSS-REFERENCE TO RELATED APPLICATIONS

The present application claims priority based on Japanese Patent Application No. 2024-180783 filed with the Japan Patent Office on Oct. 16, 2024, the entire contents of which are incorporated herein by reference.

### BACKGROUND

The present disclosure relates to an electrode wire for electrical discharge machining.

Wire electrical discharge machining is machining for cutting a workpiece by generating an electrical discharge phenomenon between an electrode wire for electrical discharge machining and the workpiece. Wire electrical discharge machining is suitable for manufacturing a product having a complicated shape, such as a mold. An electrode wire for electrical discharge machining is disclosed in Japanese Unexamined Patent Application Publication No. H09-11048 (Patent Document 1) and Japanese Unexamined Patent Application Publication No. 2024-39167 (Patent Document 2). Electrode wires for electrical discharge machining are required to be capable of high-speed electrical discharge machining and to be excellent in automatic connectivity. Recently, improvement in dimensional accuracy and surface roughness of a workpiece has been required. As a material of the electrode wire for electrical discharge machining, brass, which is an alloy of copper and zinc, is used. The brass that has been widely used heretofore is 65/35 brass having a composition of 65 mass % Cu and 35 mass % Zn. Studies have been conducted to increase the machining speed over the conventional electrode wire for electrical discharge machining, and one of the studies is to increase the zinc concentration in the brass composition. To enable high-speed electrical discharge machining, an electrode wire for electrical discharge machining having a composite structure in which an alloy layer with a higher zinc concentration is formed on the surface of a wire has also been proposed.

### SUMMARY

In recent years, in technical fields such as automobiles and aircraft, large mold parts and the like are increasingly manufactured by wire electrical discharge machining. When large mold parts and the like are machined, there is a growing need among users to increase machining speed. In one aspect of the present disclosure, it is preferable to provide an electrode wire for electrical discharge machining capable of increasing a machining speed.

One aspect of the present disclosure is an electrode wire for electrical discharge machining having a mass ratio of copper of 55.5 mass % or more and 58.5 mass % or less, a mass ratio of zinc of 41.5 mass % or more and 44.5 mass % or less, a diameter of 0.395 mm or more and 0.45 mm or less, and a tensile strength of 900 MPa or higher. The electrode wire for electrical discharge machining according to one aspect of the present disclosure can increase a machining speed.

### BRIEF DESCRIPTION OF THE DRAWINGS

Example embodiments of the present disclosure will be described hereinafter with reference to the accompanying drawings, in which:

FIG. 1 is a schematic view showing a state in which a workpiece having a flat plate shape is being machined by wire electrical discharge machining.

FIG. 2 is a cross-sectional view showing an orthogonal cross section of an electrode wire for electrical discharge machining.

FIG. 3 is an explanatory view showing a method of measuring a width W and the number of peaks M.

FIG. 4A is an explanatory view showing measurement positions for a width of a sample piece.

FIG. 4B is an explanatory view showing measurement positions for surface roughness on the sample piece.

### DETAILED DESCRIPTION OF EXEMPLARY EMBODIMENTS

### 1. Configuration of Electrode Wire 1 for Electrical Discharge Machining

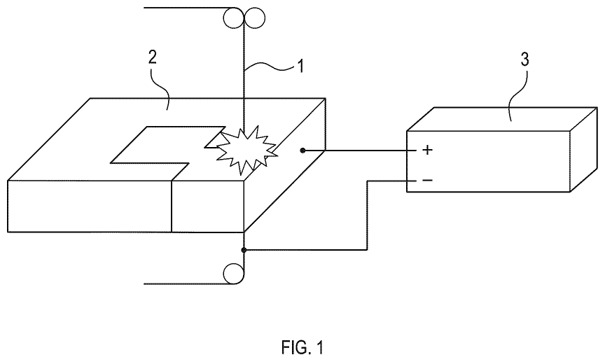

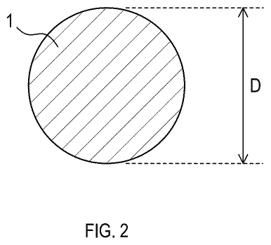

As shown in FIG. 1, an electrode wire 1 for electrical discharge machining is a linear member. The shape of the orthogonal cross section of the electrode wire 1 for electrical discharge machining is, for example, a circular shape as shown in FIG. 2. The orthogonal cross section is a cross section orthogonal to the longitudinal direction of the electrode wire 1 for electrical discharge machining.

A mass ratio of copper in the electrode wire 1 for electrical discharge machining is 55.5 mass % or more and 58.5 mass % or less. A mass ratio of zinc in the electrode wire 1 for electrical discharge machining is 41.5 mass % or more and 44.5 mass % or less. Due to the mass ratio of copper and the mass ratio of zinc being within the above ranges, the machining speed increases.

The mass ratio of copper in the electrode wire 1 for electrical discharge machining is preferably 56.5 mass % or more and 57.5 mass % or less, and more preferably 56.8 mass % or more and 57.2 mass % or less. The mass ratio of zinc in the electrode wire 1 for electrical discharge machining is preferably 42.5 mass % or more and 43.5 mass % or less, and more preferably 42.8 mass % or more and 43.2 mass % or less. The electrode wire 1 for electrical discharge machining may or may not further contain an element that is neither copper nor zinc.

A diameter D of the electrode wire 1 for electrical discharge machining shown in FIG. 2 is 0.395 mm or more and 0.45 mm or less. Due to the diameter D being 0.395 mm or more and 0.45 mm or less, a large current can flow through the electrode wire 1 for electrical discharge machining. As a result, the machining speed increases. The diameter D is preferably 0.44 mm or less, more preferably 0.43 mm or less, and particularly preferably 0.405 mm or less.

The electrode wire 1 for electrical discharge machining has a tensile strength of 900 MPa or higher. Due to the tensile strength of the electrode wire 1 for electrical discharge machining being 900 MPa or higher, the electrode wire 1 for electrical discharge machining is less likely to be disconnected. A large tension can be applied to the electrode wire 1 for electrical discharge machining. As a result, the machining speed increases. The tensile strength is measured by Japanese Industrial Standard (JIS) C 3002.

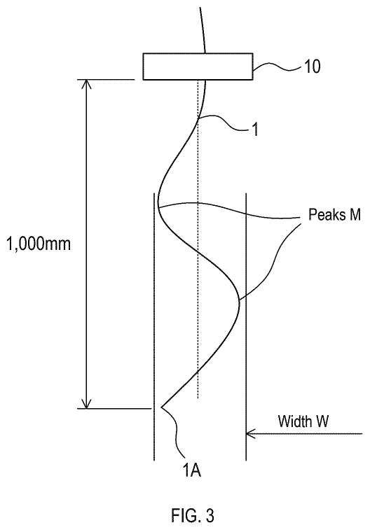

As measures indicating the straightness of the electrode wire 1 for electrical discharge machining, a width W and the number of peaks M shown in FIG. 3 are used. The width W and the number of peaks M can be measured as follows. The electrode wire 1 for electrical discharge machining having a length of 1 m or more is prepared. One end portion of the electrode wire 1 for electrical discharge machining is fixed, and the electrode wire 1 for electrical discharge machining is suspended vertically. At this time, no tension is applied to the electrode wire 1 for electrical discharge machining.

A marked line 10 is attached to a portion of the electrode wire 1 for electrical discharge machining that is 1000 mm above a lower end 1A, which is a lower end portion of the electrode wire 1 for electrical discharge machining. In the electrode wire 1 for electrical discharge machining, a horizontal length of a portion between the marked line 10 and the lower end 1A is defined as a width W. The peak M is present in a portion of the electrode wire 1 for electrical discharge machining between the marked line 10 and the lower end 1A, and has the form of a single mountain.

The smaller the width W, the higher the straightness of the electrode wire 1 for electrical discharge machining. The smaller the number of peaks M, the higher the straightness of the electrode wire 1 for electrical discharge machining. The width W is preferably 80 mm or less. The number of peaks M is preferably 2 or less. The higher straightness of the electrode wire 1 for electrical discharge machining improves the characteristics of automatic connectivity.

The electrode wire 1 for electrical discharge machining can be used as shown in FIG. 1. A pulse voltage is applied between the electrode wire 1 for electrical discharge machining and a workpiece 2 made of a metal material by a machining power supply 3. At this time, electrical discharge occurs between the electrode wire 1 for electrical discharge machining and the workpiece 2. With the electrical discharge occurring, the electrode wire 1 for electrical discharge machining is moved relative to the workpiece 2. The electrode wire 1 for electrical discharge machining is fed in a vertical direction in FIG. 1 at a predetermined speed. As a result, two-dimensional machining can be performed on the workpiece 2. The form of the workpiece 2 is, for example, a flat plate shape.

### 2. Method for Manufacturing Electrode Wire 1 for Electrical Discharge Machining

For example, the electrode wire 1 for electrical discharge machining can be manufactured by the following method.
(a) A cast billet is made. The composition of the cast billet is the same as the composition of the electrode wire 1 for electrical discharge machining.
(b) A rough-drawn wire is prepared by hot extrusion.
(c) The rough-drawn wire is subjected to heat treatment.
(d) After peeling, wire drawing and energization heat treatment are performed. The energization heat treatment is a process referred to as low-temperature annealing. Peeling means the removal of the oxide layer on the surface. Through the steps up to this point, an intermediate material T having a diameter A is obtained. A is a value greater than D. A is, for example, 1.2 mm or a value close thereto. Conditions for energization heat treatment are set so that the tensile strength of the intermediate material T is 550 MPa or higher, and the elongation is 20% or more and 27% or less.
(e) The intermediate material T having the diameter A is drawn to have a diameter D and formed into an electrode wire.

A machining degree Z (%) at this time is represented by the following Equation (1).

$$Z = ( 1 - {D}^{2} / {A}^{2} ) \times 100 \qquad Equation ( 1 )$$

The higher the machining degree Z, the higher the tensile strength of the electrode wire 1 for electrical discharge machining.
(f) The electrode wire is subjected to strain relief annealing. The strain relief annealing is a step of performing heat treatment by energizing the electrode wire. Through the steps up to this point, the electrode wire 1 for electrical discharge machining is completed. The higher the voltage V applied to the electrode wire in the strain relief annealing, the more the straightness of the electrode wire 1 for electrical discharge machining is improved, and the lower the tensile strength becomes. For example, by setting the voltage V to 18 V or more and less than 20 V, the width W can be 80 mm or less, the number of peaks M can be 2 or less, and the tensile strength can be 900 MPa or higher.
(g) The electrode wire 1 for electrical discharge machining is rewound. Rewinding means rewinding from a large bobbin to a plastic bobbin.

### 3. Effects of Electrode Wire 1 for Electrical Discharge Machining

(1A) The electrode wire 1 for electrical discharge machining has a high machining speed.
(1B) The electrode wire 1 for electrical discharge machining has high straightness.
(1C) By using the electrode wire 1 for electrical discharge machining, surface accuracy can be improved. For example, when the electrode wire 1 for electrical discharge machining is used, a surface roughness Ry on the machined surface can be reduced.

### 4. Examples

### (1) Manufacture of Electrode Wire S1 for Electrical Discharge Machining

An electrode wire S1 for electrical discharge machining was manufactured by the method described above. The mass ratio of copper in the cast billet was 57 mass %, and the mass ratio of zinc was 43 mass %. The diameter A of the intermediate material T was 1.2±0.01 mm. The tensile strength of the intermediate material T was 592 MPa. The elongation of the intermediate material T was 26.4%. The term “elongation” means elongation at break.

The tensile strength of the intermediate material T is preferably 550 MPa or higher, and more preferably 570 MPa or higher. The elongation of the intermediate material T is preferably 20% or more and 27% or less, and more preferably 20% or more and 25% or less. When the elongation of the intermediate material T is 20% or more, the machining degree Z decreases, and the risk of disconnection in the above step (e) decreases. When the elongation of the intermediate material T is 27% or less, the tensile strength of the electrode wire S1 for electrical discharge machining increases. By performing energization heat treatment in the above step (d), it is possible to increase the tensile strength of the electrode wire S1 for electrical discharge machining while reducing the risk of disconnection in the above step (e). The machining degree Z was 88.89%. The voltage V in the strain relief annealing was 19 V.

The mass ratio of copper in the electrode wire S1 for electrical discharge machining was 57 mass %, and the mass ratio of zinc was 43 mass %. The diameter D was 0.4 mm. The tensile strength of the electrode wire S1 for electrical discharge machining was 937 MPa. The width W of the electrode wire S1 for electrical discharge machining was 80 mm, and the number of peaks M was 1.

### (2) Manufacture of Electrode Wire S2 for Electrical Discharge Machining

An electrode wire S2 for electrical discharge machining was manufactured basically in the same manner as in the method for manufacturing the electrode wire S1 for electrical discharge machining. However, in the manufacture of the electrode wire S2 for electrical discharge machining, the diameter A was 0.9 mm, and the machining degree Z was 80.25%. The tensile strength of the electrode wire S2 for electrical discharge machining was 872 MPa.

### (3) Manufacture of Electrode Wires S3 to S4 for Electrical Discharge Machining

Electrode wires S3 to S4 for electrical discharge machining were manufactured basically in the same manner as in the method for manufacturing the electrode wire S1 for electrical discharge machining. However, the voltage V applied to the electrode wire for electrical discharge machining in the strain relief annealing was 0 V for the electrode wire S3 for electrical discharge machining and 17 V for the electrode wire S4 for electrical discharge machining. Table 1 shows some of the manufacturing conditions and characteristics of the electrode wires S1 and S3 to S4 for electrical discharge machining. Note that “Elongation” in Table 1 means elongation at break.

TABLE 1

| Electrode wire for | Voltage V in | | Tensile | | | |
|---|---|---|---|---|---|---|
| electrical discharge | strain relief | Diameter D | strength | Elongation | Width W | Number of |
| machining | annealing | (mm) | (MPa) | (%) | (mm) | peaks M |
| S3 | 0 V | 0.400 | 947.8 | 3.3 | 100 or more | 1 |
| S4 | 17 V | 0.400 | 984.4 | 2.8 | 90 | 1 |
| S1 | 19 V | 0.399 | 941.4 | 2 | 45 | 1 |

### (2) Evaluation of Electrode Wire for Electrical Discharge Machining

### (2-1) Evaluation of Machining Speed

Wire electrical discharge machining was performed using the electrode wire S1 for electrical discharge machining. Machining conditions were as follows.
Wire electrical discharge machine model: Makino Milling Machine Co., Ltd. U86
Material and thickness of workpiece 2: steel material LPH62, 30 mm

Linear machining was performed over a length of 22 mm. The machining speed was calculated from the time required for linear machining and 22 mm. The machining speed was 4.55 mm/min.

Wire electrical discharge machining was similarly performed using the electrode wire S2 for electrical discharge machining instead of the electrode wire S1 for electrical discharge machining, and the machining speed was calculated. The machining speed was 4.40 mm/min. Wire electrical discharge machining was similarly performed using a commercially available electrode wire R for electrical discharge machining instead of the electrode wire S1 for electrical discharge machining, and the machining speed was calculated. The machining speed was 4.11 mm/min.

### (2-2) Evaluation of Dimensional Accuracy

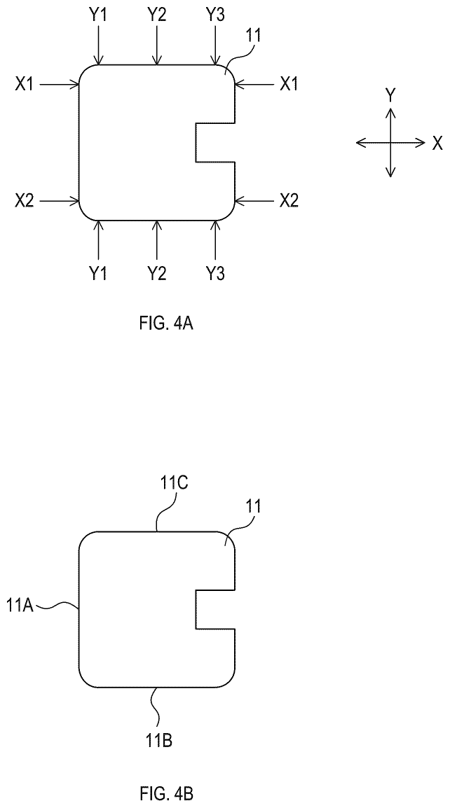

Wire electrical discharge machining was performed using the electrode wire S1 for electrical discharge machining, and a sample piece 11 shown in FIG. 4A was cut out from the workpiece 2. The basic form of the sample piece 11 was a square plate shape in plan view. The target value of the length of one side of the square was 8.000 mm.

The width of the sample piece 11 in the Y direction was measured at each of positions of Y1, Y2, and Y3 shown in FIG. 4A. The Y direction was a direction orthogonal to the thickness direction of the sample piece 11 and orthogonal to two opposing sides of the square. The width measurement described above was performed at three positions in the thickness direction of the sample piece 11 at each of the positions of Y1, Y2, and Y3. The three points are “Upper”, “Middle”, and “Lower” as shown in Table 2. “Middle” is the center in the thickness direction. “Upper” is a position closer to one main surface of the sample piece 11 than “Middle”. “Lower” is a position closer to the main surface on the opposite side of the sample piece 11 than “Middle”. Table 2 shows the measurement results.

TABLE 2

| | | | | | | | | | | | | | Unit: mm |
|---|---|---|---|---|---|---|---|---|---|---|---|---|---|
| | | R | | | | | | S1 | | | | | |
| | | Y1 | | Y2 | | Y3 | | Y1 | | Y2 | | Y3 | |
| | Target | Measured | | Measured | | Measured | | Measured | | Measured | | Measured | |
| | value | value | Error | value | Error | value | Error | value | Error | value | Error | value | Error |
| Upper | 8.000 | 8.001 | +0.001 | 8.001 | +0.001 | 8.001 | +0.001 | 7.998 | −0.002 | 7.998 | −0.002 | 7.998 | −0.002 |
| Medium | | 7.999 | −0.001 | 7.999 | −0.001 | 7.999 | −0.001 | 7.998 | −0.002 | 7.997 | −0.003 | 7.997 | −0.003 |
| Lower | | 8.000 | 0.000 | 8.000 | 0.000 | 7.999 | −0.001 | 7.998 | −0.002 | 7.998 | −0.002 | 7.997 | −0.003 |

| | | | | | | |
|---|---|---|---|---|---|---|
| Max | 8.001 | 8.001 | 8.001 | 7.998 | 7.998 | 7.998 |
| Min | 7.999 | 7.999 | 7.999 | 7.998 | 7.997 | 7.997 |
| Difference | 0.002 | 0.002 | 0.002 | 0.000 | 0.001 | 0.001 |

“Error” in Table 2 is a difference from the target value of 8.000 mm. Table 2 shows “Max”, “Min”, and “Difference” in each of Y1, Y2, and Y3. “Max” is the maximum value among the measured values at “Upper”, “Middle”, and “Lower”. “Min” is the minimum value among the measured values at “Upper”, “Middle”, and “Lower”. “Difference” is a value obtained by subtracting “Min” from “Max”.

The width of the sample piece 11 in the X direction was measured at each of positions of X1 and X2 shown in FIG. 4A. The X direction was a direction orthogonal to the thickness direction of the sample piece 11 and orthogonal to the Y direction. The width measurement described above was performed at three positions in the thickness direction of the sample piece 11 at each of the positions of X1 and X2. The three points are “Upper”, “Middle”, and “Lower” as shown in Table 3. “Middle” is the center in the thickness direction. “Upper” is a position closer to one main surface of the sample piece 11 than “Middle”. “Lower” is a position closer to the main surface on the opposite side of the sample piece 11 than “Middle”. Table 3 shows the measurement results.

TABLE 3

| | | | | | | | | | Unit: mm |
|---|---|---|---|---|---|---|---|---|---|
| | | R | | | | S1 | | | |
| | | X1 | | X2 | | X1 | | X2 | |
| | Target | Measured | | Measured | | Measured | | Measured | |
| | value | value | Error | value | Error | value | Error | value | Error |
| Upper | 8.000 | 8.001 | +0.001 | 8.001 | +0.001 | 7.998 | −0.002 | 7.999 | −0.001 |
| Medium | | 7.999 | −0.001 | 7.999 | −0.001 | 7.998 | −0.002 | 7.998 | −0.002 |
| Lower | | 7.999 | −0.001 | 7.999 | −0.001 | 7.998 | −0.002 | 7.998 | −0.002 |

| | | | | |
|---|---|---|---|---|
| Max | 8.001 | 8.001 | 7.998 | 7.999 |
| Min | 7.999 | 7.999 | 7.998 | 7.998 |
| Difference | 0.002 | 0.002 | 0.000 | 0.001 |

“Error” in Table 3 is a difference from the target value of 8.000 mm. Table 3 shows “Max”, “Min”, and “Difference” in each of X1 and X2. “Max” is the maximum value among the measured values at “Upper”, “Middle”, and “Lower”. “Min” is the minimum value among the measured values at “Upper”, “Middle”, and “Lower”. “Difference” is a value obtained by subtracting “Min” from “Max”.

Similar wire electrical discharge machining and measurement were performed using a commercially available electrode wire R for electrical discharge machining instead of the electrode wire S1 for electrical discharge machining. Tables 2 and 3 show the results. As shown in Tables 2 and 3, “Difference” in the case of using the electrode wire S1 for electrical discharge machining was smaller than “Difference” in the case of using the electrode wire R for electrical discharge machining. This result indicates that the dimensional accuracy is high when the electrode wire S1 for electrical discharge machining is used.

### (2-3) Evaluation of Surface Roughness Ry

Wire electrical discharge machining was performed using the electrode wire S1 for electrical discharge machining, and a sample piece 11 shown in FIG. 4B was cut out from the workpiece 2. The form of the sample piece 11 was the same as the form of the sample piece 11 in “(2-2) Evaluation of dimensional accuracy” described above. As shown in FIG. 4B, three sides of the sample piece 11 were set as sides 11A, 11B, 11C, respectively. In each of the sides 11A, 11B, 11C, the surface roughness Ry on the end surface of the sample piece 11 was measured. The surface roughness Ry corresponds to Rz in JIS B 0601:2001. For measuring the surface roughness Ry, Surfcorder SE3500 manufactured by Kosaka Laboratory Ltd. was used.

On each of the sides 11A, 11B, 11C, the surface roughness Ry was measured at “Upper”, “Middle”, and “Lower” in the thickness direction of the sample piece 11 and measured in “Wire running direction”. The meanings of “Upper”, “Middle”, and “Lower” are the same as those of “Upper”, “Middle”, and “Lower” in “(2-2) Evaluation of dimensional accuracy” described above. “Wire running direction” means the vertical direction in FIG. 1. Table 4 shows the measurement results.

TABLE 4

| | | | | | Unit: μm | |
|---|---|---|---|---|---|---|
| | R | | | S1 | | |
| | 11A | 11B | 11C | 11A | 11B | 11C |
| Upper | 4.12 | 4.58 | 4.27 | 3.87 | 3.56 | 4.04 |
| Medium | 3.94 | 4.01 | 3.88 | 3.80 | 4.26 | 3.70 |
| Lower | 4.36 | 4.39 | 4.71 | 4.31 | 4.74 | 4.02 |
| Wire running direction | 4.03 | 4.22 | 4.71 | 4.12 | 3.71 | 3.78 |

Similar wire electrical discharge machining and measurement were performed using a commercially available electrode wire R for electrical discharge machining instead of the electrode wire S1 for electrical discharge machining. Table 4 shows the results. As shown in Table 4, the surface roughness Ry in the case of using the electrode wire S1 for electrical discharge machining was smaller than the surface roughness Ry in the case of using the electrode wire R for electrical discharge machining. This result indicates that the surface roughness Ry is small when the electrode wire S1 for electrical discharge machining is used.

### 5. Other Embodiments

Although the embodiments of the present disclosure have been described above, the present disclosure is not limited to the embodiments described above, and various modifications can be made.

(1) A function of one component in each of the embodiments may be shared by a plurality of components, or functions of a plurality of components may be exerted by one component. A part of the configuration of each of the embodiments may be omitted. At least a part of the configuration of each of the embodiments may be added to, replaced with, or the like, with respect to the configuration of another embodiment.

(2) In addition to the electrode wire 1 for electrical discharge machining described above, the present disclosure can be implemented in various forms, such as a system including the electrode wire 1 for electrical discharge machining as a component, a method for manufacturing the electrode wire 1 for electrical discharge machining, and a method of wire electrical discharge machining.

What is claimed is:

1. An electrode wire for electrical discharge machining, comprising:
a mass ratio of copper of 55.5 mass % or more and 58.5 mass % or less;
a mass ratio of zinc of 41.5 mass % or more and 44.5 mass % or less;
a diameter of 0.395 mm or more and 0.45 mm or less; and
a tensile strength of 900 MPa or higher.

2. The electrode wire for electrical discharge machining according to claim 1, wherein, when the electrode wire for electrical discharge machining is suspended vertically, a portion of the electrode wire for electrical discharge machining within a range of 1 m from a lower end has a horizontal width of 80 mm or less.
